(19) United States
(12) Patent Application Publication
(10) Pub. No.: US 2006/0058212 A1
(43) Pub. Date: Mar. 16, 2006

(54) Scavenging substrate

(76) Inventor: Patrick McNamee, Rochestown (IE)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/543,239

(22) PCT Filed: Jan. 27, 2004
(86) PCT No.: PCT/IE04/00016

§ 371 Date: Jul. 22, 2005

(30) Foreign Application Priority Data
Jan. 27, 2003 (IE) S20030043

(51) Int. Cl. C11D 3/37

(52) U.S. Cl. 510/499; 510/276

(57) ABSTRACT

A scavenging substrate comprising an absorbent substrate bearing a soil scavenging compound having the formula (I), wherein R¹ and R² are each independently hydrogen, C₁₋₅-alkyl or phenyl, X⁻ is an anion, Y⁺ is a cation, m is 1-5 and n is 30-5000; and, optionally, a dye scavenging compound selected from the following compounds: (i) N-trisubstituted ammonium-2-hydroxy-3-halopropyl compound having the formula (II).

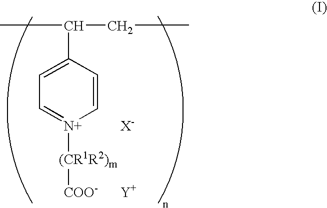

The present invention relates to an improved scavenging substrate, in particular, a scavenging substrate for scavenging dye and soil from laundry wash liquor and from articles present in the wash liquor.

It is well known that white articles, such as clothes, sheets and the like, do not remain white for long periods of time. Such articles are susceptible to a greying effect over time as they are put through numerous laundry cycles. Although during a wash soil and dirt are removed from the articles, the soil and dirt are free in the wash liquor to be re-deposited on the articles present in the wash. Thus, this greying effect is generally caused by the build up of such soil and dirt. The types of fibres commonly found in white garments include cotton, nylon, polycotton, polyester and Lycra (Trade Mark). Attempts to reduce the unsightly greying of such articles include the use of bleach to return the garments to their original colour, once the white colour has faded to grey. In particular, Lycra, which is used in undergarments, tends to go greyer more quickly than other fibres. However, chemical agents such as bleach are harsh and can result in the degradation of the fibres of the article over time. Another associated problem is the yellowing of such articles over time, which is generally caused by inadequate rinsing of the alkali component present in many laundry detergents.

Another known problem is that of the fading of dyed articles in a laundry wash. Although fading of dyes is more prevalent from new, unlaundered, or heretofore infrequently laundered goods, even articles with considerable fastness to washing, or having a long history of numerous previous launderings, may continue to bleed small amounts of dyestuff or col rant into the bath or wash water. The well known, but aggravating and undesirable result of such fading is that at least part of the extraneous, free flowing dyestuff which has bled from its original material substrate may then be absorbed, adsorbed, reacted with, or otherwise physically deposited on or associated with other articles in the same wash liquor, thus discolouring this latter item.

Attempts to solve this problem have included treating the dyes or colorants so that they have a greater affinity for the dyed material. Attempts have also been made to eliminate dyestuffs discharged in the wash water. International Patent Application WO-A-97/48789 discloses a method of controlling undesirable dye or colorant discharged in wash water, comprising placing in the wash a dye scavenger member which when added to the wash scavenges and absorbs extraneous dye.

It is an object of this invention to provide an improved scavenging substrate which mitigates the problems associated with the prior art. It is a further object of the invention to provide an improved scavenging substrate capable of scavenging dye and/or soil in a laundry wash.

The invention, therefore, provides a scavenging substrate comprising an absorbent substrate bearing a soil scavenging compound having the general formula (I): 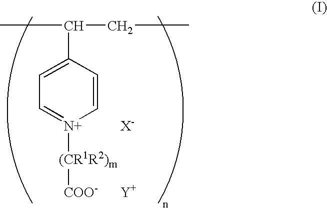
wherein R¹ and R² are each independently hydrogen, C₁₋₅-alkyl or phenyl; X⁻ is an anion, Y⁺ is a cation, m=1-5 and n is 30-5000.

Preferably, the scavenging substrate also bears a dye scavenging compound selected from the following compounds:
(i) N-trisubstituted ammonium-2-hydroxy-3-halopropyl compound having the general formula (II) 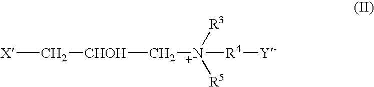
   wherein R³, R⁴, R⁵ are each independently methyl, ethyl, butyl or benzyl or an hydroxyl substituted derivative thereof, X′ is a halogen atom, and Y′⁻ is chloride, bromide, sulfate or sulfonate; and
(ii) a salt of epoxy propyl ammonium having the general formula (III), 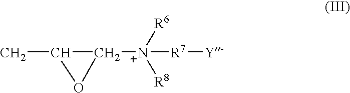
   wherein R⁶, R⁷, R⁸ and Y″⁻ have the same meaning as R³, R⁴, R⁵ and Y′⁻, respectively, as defined above; or a combination thereof.

As used herein, a “soil scavenging compound” is a compound which generally inhibits any soil or dirt present in a laundry wash liquor from being undesirably absorbed, adsorbed, reacted with, or otherwise physically deposited on or associated with articles in the wash liquor. The soil scavenging compound is generally releasably associated with the absorbent substrate and is preferably applied to, adsorbed by, or impregnated into the substrate. The soil scavenging compound is a compound which has a high affinity for soil and dirt, and is generally capable of complexing therewith, as will be explained hereinafter.

As used herein, a “dye scavenging compound” is a compound which generally inhibits any dyestuff or colorant present in wash water from being undesirably absorbed, adsorbed, reacted with, or otherwise physically deposited on or associated with articles in the wash water. The dye scavenging compound which is applied to, adsorbed by, or impregnated into the absorbent substrate is generally a compound which has a high affinity for dyes or colorants and is generally capable of complexing therewith, as will be explained hereinafter.

The soil scavenging compound used in the present invention is preferably a compound of the formula (I) in which R¹ and R² are each hydrogen, X⁻ is a halide, Y⁺ is an alkali metal cation, m is 1-3 and n is 30-5000. More preferably, R¹ and R² are each hydrogen, X⁻ is Cl⁻ or Br⁻, Y⁺ is Na⁺ or K⁺, m is 1 and n is 100-1000. A particularly preferred soil scavenging compound (I) is a poly(vinylpyridine betaine) polymer, especially poly(4-vinylpyridine) sodium carboxymethyl betaine chloride. This compound is sold under the trade name Chromabond.

The soil scavenging compound (I) is preferably present in an amount of from approximately 2 g to 12 g per square metre of absorbent substrate, more preferably from approximately 4 g to 10 g, most preferably approximately 6.5 g to 7.5 g, and especially approximately 6.6 g per square metre of absorbent substrate.

A particularly preferred dye scavenging compound used in the present invention is a compound of the formula (II) which is 3-chloro-2-hydroxypropyltrimethylammonium chloride. Another particularly preferred dye scavenging compound is a compound of the formula (III) which is glycidyltrimethylammonium chloride, also known as (2,3-epoxypropyl)trimethylammonium chloride.

The dye scavenging compound (II) and/or (III) is preferably present in an amount of from approximately 10 g to 30 g, more preferably from approximately 15 g to 25 g, especially approximately 20 g per square metre of absorbent substrate.

While compounds (I) are particularly effective as soil scavenging compounds, they may also have dye transfer inhibiting properties.

The absorbent substrate may be formed from any suitable material. Suitable materials have the ability to absorb and retain a sufficient amount of the soil and dye scavenging compounds. Examples of suitable materials include cellulosic materials such as paper, textile materials, naturally occurring materials and synthetic materials, and mixtures thereof. Textile materials include woven and non-woven materials, such as cotton, cotton mixes, knitted fabrics, braided rope or bail. The absorbent substrate may conveniently comprise cotton. A preferred substrate comprises a blend of viscose and cotton, the ratio of viscose to cotton preferably being approximately 90:10 to 10:90, more preferably 50:50.

A particularly preferred substrate is in the form of a woven mesh, the mesh having pores of approximately 0.1 mm-0.3 mm. Such pores are of a size suitable to enable particles of soil to become trapped in the substrate, as will be explained hereinafter. The dimensions of the substrate are approximately 25 cm×12 cm. It will, however, be appreciated that any other suitable dimensions may be used. The absorbent substrate material preferably has a weight of from about 40 g/m² to 200 g/m², more preferably from about 55 g/m² to 80 g/m², most preferably approximately 60 g/m².

The soil scavenging compounds (I) are typically cationic in nature, and are releasably associated with the absorbent substrate. In contrast, the soil and dirt present in the wash liquor are anionic in nature. The soil and dirt may be present in the form of particles, forming a suspension within the wash liquor. Alternatively, the soil and dirt may dissolve within the wash liquor to form a solution.

During a wash cycle, and without wishing to be bound by theory, the Applicant proposes that the soil scavenging compound leaches from the substrate into the wash liquor to become evenly distributed throughout the wash liquor. The cationic soil scavenging compound reacts with the anionic soil particles which have been removed from the articles being washed, now present in the wash liquor, forming a complex. This complex remains in the wash liquor and the soil is thus prevented from being re-deposited onto the articles. Compounds (I) can therefore be referred to as anti-soil re-deposition agents.

During the rinsing phase of the wash cycle, the compound (I)/soil complexes are rinsed away, thus removing the soil from the wash. In this manner, the soil scavenging compound has the advantageous effect of “mopping up” the soil and dirt present on the articles, and then providing a means (i.e. the complex) to prevent the soil from being re-deposited on any articles present in the wash.

The dye scavenging compound is also cationic in nature. However, in contrast with the soil scavenging compound, the dye scavenging compound (II) and/or (III) is fixedly associated with the absorbent substrate. The dyes and colourants present in the wash are anionic in nature, and they tend to be fully in solution in the wash liquor (in contrast with the soil and dirt particles).

During the wash, the cationic dye scavenging compound (II) and/or (III) complexes with the anionic dyes and colourants which have bled from the articles in the wash liquor. However, unlike the soil scavenging compound (I), the dye scavenging compound (II) and/or (III) is not leached from the substrate during the wash. Thus, the complexes formed between the dye scavenging compound and the dye, gives the substrate a coloured appearance due to the presence of the dye complexed thereto.

The substrate itself when in the form of a mesh may provide the improved scavenging substrate of the invention with a further advantage. Since the pores are suitable for receiving and retaining soil particles within the pores, some of the soil particles originally present on the articles being washed, may become trapped in the pores of the substrate. If any of these particles become free during the course of the wash cycle, the soil scavenging compound will “mop up” these soil particles as previously described herein.

The scavenging substrate of the invention may be prepared by a method comprising the steps of:
(a) providing an absorbent substrate; and
(b) applying to the substrate a soil scavenging compound (I) as defined above.

In step (b), the soil scavenging compound (I) may be applied to the absorbent substrate by spraying a solution of the compound on the substrate. Alternatively, the soil scavenging compound (I) may be applied to the substrate by immersing the substrate in an aqueous solution of this compound.

When the scavenging substrate also includes a dye scavenging compound (II) and/or (III), the method further comprises the steps of:
(a)(i) providing an aqueous solution containing a dye scavenging compound of the formula (II) and/or (III) as defined above, or a combination thereof; and
(a)(ii) at least partially impregnating the absorbent substrate with said aqueous solution, the steps (a)(i) and (a)(ii) being performed prior to step (b).

Preferably, the aqueous solution of step (a)(i) is an alkaline solution. Further preferably, the alkaline solution is at a temperature of from about 30° C. to 50° C., most preferably approximately 45° C.

Preferably, step (a)(ii) includes one or more of the following steps:
(i) subjecting the treated substrate to a pressure of from about 0.69 to 1.37 Pa (100-200 psi), preferably about 1.03 Ma (150 psi), and, preferably, the pressure is obtained by passing the substrate between a pair of hydraulically actuated rollers, further preferably, at a rate of from about 184 mm s⁻¹ to 167 mm s⁻¹, most preferably about 175 mm s⁻¹;
(ii) heating the substrate to a temperature of approximately 35° C., wherein, preferably, the heating is achieved by passing the substrate through a series of rollers having a temperature of approximately 100° C. so that the substrate exiting the rollers is at a temperature of between 30° C. and 40° C., preferably about 35° C.;
(iii) wrapping the substrate in a water impermeable material and rotating the material at a temperature of from about 15° C. to 100° C. for a period of from about 1 to 12 hours, preferably approximately 100° C. with a storage time of a minimum of 6 hours.
(iv) removing the water impermeable material and passing the substrate through an acid bath;
(v) subjecting the substrate to a pressure of from about 1.03 to 1.72 MPa (150-250 psi); preferably approximately 1.38 MPa (200 psi), and, preferably, the substrate is passed through the rollers at a rate of from about 92 mm s⁻¹ to 75 mm s⁻¹, further preferably approximately 83 mm s⁻¹; and
(vi) drying the substrate, preferably by subjecting the substrate to a temperature of from about 95° C. to 115° C., most preferably about 105° C.

The scavenging substrate of the present invention may, for example, be prepared using the apparatus disclosed in International Patent Application WO-A-97/48789.

The following Examples serves to illustrate the invention but it will be appreciated that the invention is not limited to these Examples.

### EXAMPLE 1

The amounts of the ingredients shown below were used to make one square metre of a scavenging substrate according to the invention:

| Ingredients | Amount | |
|---|---|---|
| Woven material¹ | 1 | sq m |
| NaOH 30% | 17.7 | g |
| Reagens CFZ² | 19.7 | g |
| Fresh Linen 75618³ | 0.235 | g |
| 36% HCl | 0.0083 | liters |
| Chromabond (Compound (I)) | 6.6 | g |

¹The woven material comprises a one square metre sheet of 50:50 viscose:cotton;
²Reagens CFZ is the dye scavenging compound (II) (3-chloro-2-hydroxypropyltrimethylammonium chloride);
³Fresh Linen 75618 is a component providing fragrancy.

The substrate was prepared by passing the woven sheet through an alkaline solution (30% NaOH solution) of Reagens CFZ at 45° C. The substrate was subsequently subjected to a pressure of approximately 1.03 MPa (150 psi) by being passed through hydraulically actuated rollers at a rate of approximately 175 mm s⁻¹. The substrate was then heated by passing it through a series of rollers having a temperature of 100° C., the substrate exiting the rollers having a temperature of 35° C. The substrate was stored for approximately six hours rotating continuously. Subsequently, the substrate was passed through an acid solution comprising 5 molar HCl solution. The substrate was subjected to a pressure of 1.37 Mpa (200 psi) by being passed through rollers at a rate of 83 mm s⁻¹. An infra red dryer operating at 286° C. was used to dry the substrate. During this final drying stage, a preferred 10% solution of Chromabond was applied to the substrate by means of a spray gun, such that the final weight of Chromabond was 6.6 g per square metre of substrate (i.e. approximately 0.2 g per 12.5 cm×25.0 cm sample). The substrate was dried completely prior to use.

### EXAMPLE 2

The following tests were performed on a white cloth in order to show the improved results obtained using the scavenging substrate of Example 1.

| | TEST A | TEST B (Reference) | TEST C (Control) |
|---|---|---|---|
| Cloth | 9 × 7 cm Lycra (95% | 9 × 7 cm Lycra (95% | 9 × 7 cm Lycra (95% |
| | polyamide/ | polyamide/ | polyamide/ |
| | 5% elastane)ⁱ | 5% elastane)ⁱ | 5% elastane)ⁱ |
| Cloths used | 2 | 2 | 2 |
| per test | | | |
| Garden soil | 2 g | — | 2 g |
| Detergent | Sainsbury's Novon Non- | Sainsbury's Novon | Sainsbury's Novon |
| | Biological with optical | Non-Biological with | Non-Biological with |
| | brighteners (0.5 g/liter | optical brighteners | optical brighteners |
| | wash water) | (0.5 g/liter wash water) | (0.5 g/liter wash water) |
| Tap Water | 1 liter | 1 liter | 1 liter |
| Scavenging | 1 substrate | — | — |
| substrate of | (12.5 cm × | | |
| Example 1 | 25.0 cm) | | |

¹cut from a Marks & Spencer ‘Urban Survival’ crew vest.

Tests A, B and C were performed according to the following procedure:

(1) The components of test A, B and C respectively were washed at 40° C. for 30 minutes. Agitation was provided by a mechanical stirrer at 100 rpm, using a 5×5 cm paddle.

(2) The pH of the wash solutions was measured (in all cases the pH of the wash solution was found to be between 8.9 and 9.1).

(3) The two cloths were rinsed at room temperature in 1 litre tap water for 3 minutes, and air-dried.

(4) dE measurements were taken using a HunterLab Color QUEST Sphere (reflectance conditions were based on CIELAB Scale for dE_{cmc} 10°/D65).

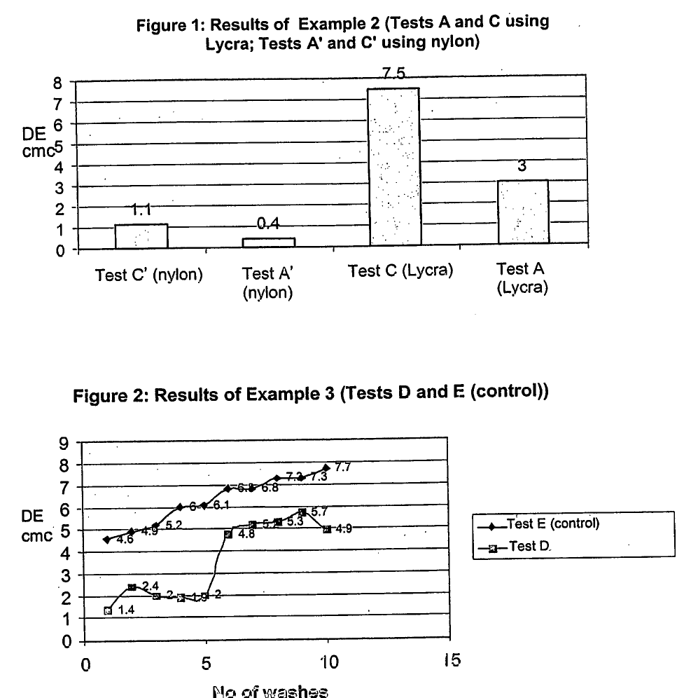

Tests A′, B′ and C′ were performed by carrying out Tests A, B and C respectively, using a 9×7 cm cloth of untreated nylon (provided by ISP, Wayne, N.J., USA) instead of Lycra. The results of all these tests are shown in FIG. 1.

Results and Discussion:

The total colour difference measurement dE_{cmc} is a technique for the quantification of colour. Using a spectrophotometer such as the HunterLab ColorQUEST Sphere, the light reflected by objects relative to a reference can be measured. There are various scales for these measurements depending on the material under test, but they are all based on the opponent colours theory of vision, where the scales correlate closely with the manner in which humans actually see colour. The CIELAB scale used in this study calculates colour difference in terms of dL* (lightness), dC* (chroma), and dH* (hue). The cmc colour difference equation was introduced by The Colour Measurement Committee of the Society of Dyers and Colourists. The cmc equation has the unique ability to determine where a particular standard or target colour lies in a colour space. For that particular region, it can further define a reasonable volume of acceptance based on the 3 components, dL*, dC* and dH*. Different industries require different sizes of tolerances based upon the types of products being manufactured and analysed. Generally a difference of 2 units of dE_{cmc} was distinguishable by the naked eye in these tests.

The dE_{cmc} values reported are an amperage of the values of the 2 cloths per wash. For each cloth, dE_{cmc} readings were taken from 3 areas of the cloth and a mean calculated. An untreated ‘Reference’ cloth (tests B and B′) was used as the standard for the total colour difference dE_{cmc}.

Referring to FIG. 1, it was found that greater differences were observed when Lycra was used as the cloth to be tested (i.e. tests A and C). Whilst there was a detectable improvement for nylon when the scavenging substrate was used (test A′), this was less than 1 dE_{cmc} unit and therefore not visible to the naked eye. However, for Lycra, a large difference of 3.5 dE_{cmc} units was measured and the improvement as a result of the scavenging substrate was clearly visible (test A). For this reason, further tests were performed using the Lycra material, as described in Example 3 below.

### EXAMPLE 3

Tests D and E (control) were performed using Lycra, by repeating the method steps (1)-(4) of tests A and C respectively, 10 times in total. The only differences were that:
6 Lycra cloths were used per wash (rather than 2 cloths as used in tests A and C of Example 2); and
The drying step (of step (3)) was performed under a hair dryer at 40° C.
   The dE_{cmc} values were measured after each wash. A new scavenging substrate was used for each wash in test D. The results are shown in FIG. 2.
   Results and Discussion:

The dE_{cmc} values reported are an average of the 6 cloths per wash. For each cloth, dE_{cmc} readings were taken from 3 areas of the cloth and the mean calculated.

Referring to FIG. 2, it was found that the control samples of test E became steadily more stained as the tests were repeated. There was a difference of 3.1 dE_{cmc} units between the first and tenth cycle, i.e. a visible deterioration in the whiteness of the Lycra.

The experimental samples of test D was much less stained after the first cycle, reading only 1.4 against 4.6 dE_{cmc} for the control of test E. This demonstrated a large, perceptible benefit from using the scavenging substrate of the present invention.

At the end of 10 cycles the Lycra washed in the presence of the scavenging substrate of Example 1 (i.e. test D) had lost some of its whiteness. The staining had increased from a reading of 1.4 to 4.9 dE_{cmc} units. However, the discolouration of the Lycra in test D after 10 cycles was not perceptibly different to the Lycra in the control wash (test E) after the first wash. Therefore 10 ‘dirty’ wash cycles in the presence of the scavenging substrate gave a visually similar result to just one wash cycle without the scavenging substrate present. It was also noted that the scavenging substrate itself was discoloured at the end of each wash cycle.

### EXAMPLE 4

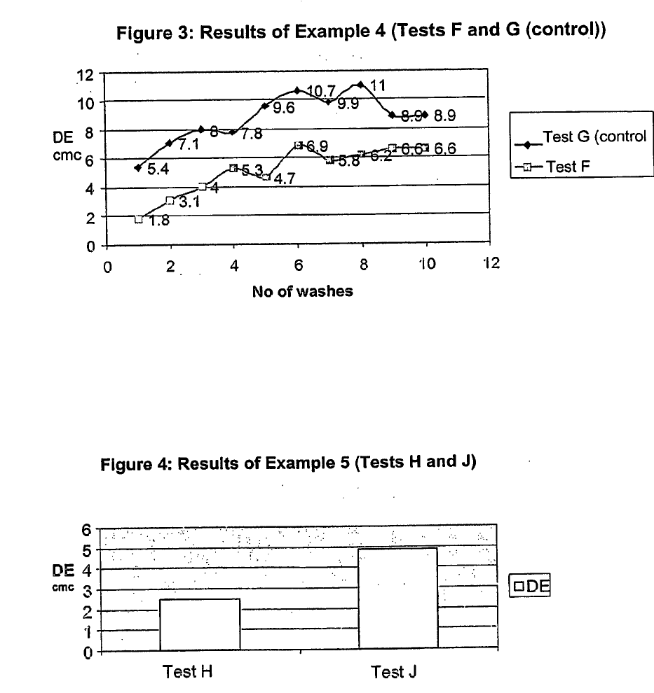

Tests F and G (control) were performed using Lycra, by repeating the method steps (1)-(4) of Tests A and C respectively, 10 times in total. The only differences were that:
6 Lycra cloths were used per wash (rather than 2 cloths as used in tests A and C of Example 2); and
The non-biological powder (0.50 g/litre of Sainsbury's Novon Non-Biological) previously used in the tests was replaced with a biological powder, ‘Tesco Value Automatic Biological Washing Powder’ (0.50 g/litre).
   The dE_{cmc} values were measured after each wash. A new scavenging substrate was used for each wash in test F. The results are shown in FIG. 3.
   Results and Discussion:

Referring to FIG. 3, it was found from test F that after one wash cycle in the presence of soil, there was a visually perceptible improvement in whiteness of the Lycra of 3.6 dE_{cmc}, using the scavenging substrate. Similar to the results produced in Example 3, Lycra repeatedly washed 10 times in the presence of soil and a scavenging substrate (6.6 dE_{cmc}) (test F) was visually similar to Lycra washed only once under identical conditions but without the scavenging substrate (5.4 dE_{cmc}) (test G (control)).

### EXAMPLE 5

The following tests H and J were performed on a white cloth in order to show the improved results obtained using Chromabond (test H) sprayed onto an untreated absorbent substrate, compared with polyvinyl pyrrolidone (PVP), which is a conventional dye scavenging compound, sprayed onto an untreated absorbent substrate (test J).

| | TEST H | TEST J |
|---|---|---|
| Cloth | 9 × 7 cm | 9 × 7 cm |
| | white cotton | white cotton |
| Cloths used | 2 | 2 |
| per test | | |
| Garden soil | 2 g | 2 g |
| Detergent | Sainsbury's Novon Non- | Sainsbury's Novon |
| | Biological with optical | Non-Biological with |
| | brighteners (0.5 g/liter | optical brighteners |
| | wash water) | (0.5 g/liter wash |
| | | water) |
| Tap Water | 1 liter | 1 liter |
| Scavenging | 1 untreated absorbent | 1 untreated absorbent |
| member | substrate | substrate |
| | (12.5 cm × 25.0 cm); | (12.5 cm × 25.0 cm); |
| | 0.2 g Chromabond | 0.2 g PVP |

Tests H and J were performed according to the following procedure:

(1) The components of tests H and J respectively were washed at 60° C. for 30 minutes. Agitation was provided by a mechanical stirrer at 100 rpm, using a 5×5 cm paddle.

(2) The pH of the wash solutions was measured (in all cases the pH of the wash solution was found to be between 8.9 and 9.1).

(3) The two cloths were rinsed at room temperature in 1 litre tap water for 3 minutes, and air-dried.

(4) dE measurements were taken using a HunterLab ColourQUEST Sphere (reflectance conditions were based on CIELAB Scale for dE_{cmc} 10°/D65).

The results of these tests are shown in FIG. 4. The dE_{cmc} values for Examples 5-8 reported are an average of the values of the 2 cloths per wash. For each cloth, dE_{cmc} readings were taken from 3 areas of the cloth and a mean calculated.

### EXAMPLE 6

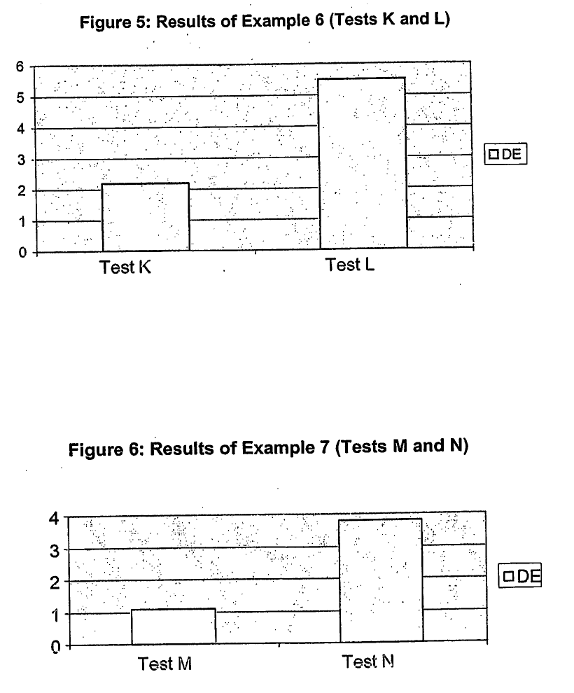

Tests K and L were performed by repeating the method steps (1)-(4) of Test H and J, but by replacing the 2 g soil used in each case with 2 g Direct Red Dye (Trade Mark) (supplied by LE Blackburne, Belfast, Northern Ireland). The results of these tests are shown in FIG. 5.

Results and Discussion (Examples 5 and 6)

Referring to FIGS. 4 and 5, both tests H and K used Chromabond (compound (I)), and produced results of 2.5 and 2.9 dE_{cmc} units for Examples 5 and 6 using soil and dye respectively. In comparison, tests J and L used PVP and produced respective results of 4.9 and 5.5 dE_{cmc} units for soil and dye. These results show that Chromabond used on its own with an absorbent substrate yields significantly better results than PVP used on its own, both when used with soil (Example 5, FIG. 4) and when used with dye (Example 6, FIG. 5).

It was also noted, from both Examples 5 and 6, that, similar to Chromabond, PTP appeared to be quite soluble in the wash liquor (i.e. releasably associated with the absorbent substrate), but PVP also seemed to redeposit onto the untreated absorbent substrate after complexing with the dye/soil in solution. Although it was only expected to see a colour change on the absorbent sheet where the PVP was applied, it was noted that the whole sheet was uniformly affected by soil (Example 5) or dye (Example 6). This was in direct comparison to the sheet of tests H and K (using Chromabond) where only the area to which the Chromabond was applied was affected.

From these observations from Examples 5 and 6, and without wishing to be bound by theory, it is postulated that the PVP had left the area where it was originally sprayed on, gone into solution, complexed with the soil (Example 5) or dye (Example 6) and redeposited back onto the sheet. It was also noted that the white cotton cloth had turned to pink when using the PVP (Tests J and L) which led to the conclusion that not only was the complexed soil/dye being redeposited onto the sheet but it was also being deposited onto the cotton too.

In contrast, in Tests H and K it was observed that there was little to no soil/dye pick up on the untreated absorbent sheet, thus indicating that Chromabond does not appear to be deposited back onto the sheet like PVP. This result for Chromabond was expected, as the soil/dye would not have a great affinity for the absorbent substrate. This would appear to support the conclusion that in tests J and L, PVP was redeposited on the sheet after complexing with soil (Example 5) or dye (Example 6).

### EXAMPLE 7

The following tests were performed on a white cloth in order to show the improved results obtained using the scavenging substrate of Example 1 compared with a second scavenging substrate prepared by replacing the solution of Chromabond applied to the substrate during the final drying stage with a solution of polyvinyl pyrrolidone (PVP).

Tests M and N were performed by repeating the method steps (1)-(4) of Example 5. Test M used the scavenging substrate (12.5 cm×25 cm) of Example 1 (which substrate included 0.2 g Chromabond applied as a solution during the final stage of Example 1). Test N used a substrate of Example 1 except that 0.2 g PVP was present on the substrate instead of 0.2 g Chromabond.

The results of these tests are shown in FIG. 6.

Results and Discussion

Referring to FIG. 6, the substrate of Example 1 used in test M (using Chromabond) is shown to yield significantly better results than the substrate used in test N (using PVP). The respective dE_{cmc} readings for Test M and Test N were 1.1 and 3.8. The colour change was much more noticeable in the white cloth when using the substrate of Test N, showing that the use of Chromabond (compound (I)) on a substrate bearing a dye scavenging compound produces superior results to the use of PVP on such a substrate.

### EXAMPLE 8

The following tests P, Q and R were performed on a white cloth in order to show the improved results obtained using the scavenging substrate of Example 1 (test P), compared with Chromabond on its own (test Q), and also compared with a scavenging substrate prepared according to the method as set out in Example 1 but without applying the Chromabond of step (b) (test R).

| | TEST P | TEST Q | TEST R |
|---|---|---|---|
| Cloth | 9 × 7 cm | 9 × 7 cm | 9 × 7 cm |
| | white cotton | white cotton | white cotton |
| Cloths used | 2 | | 2 |
| per test | | | |
| Gardensoil | 2 g | 2 g | 2 g |
| Detergent | Sainsbury's Novon Non- | Sainsbury's Novon | Sainsbury's Novon |
| | Biological with optical | Non-Biological with | Non-Biological with |
| | brighteners (0.5 g/liter | optical brighteners | optical brighteners |
| | wash watery | (0.5 g/liter wash water) | (0.5 g/liter wash water) |
| Tap Water | 1 liter | 1 liter | 1 liter |
| Scavenging | 1 substrate of Example 1 | 0.2 g of Compound (I) | 1 substrate of Example |
| member | (12.5 cm × 25.0 cm) | | 1 without Compound |
| | | | (I) |
| | | | (12.5 cm × 25.0 cm) |

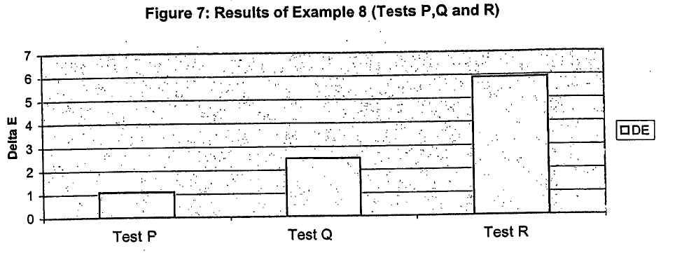

Tests P, Q and R were performed according to procedure of Example 5. The results of these tests are shown in FIG. 7.

Results and Discussion

The purpose of tests P, Q and R was to show that the combination of compound (I) and compounds (II) and/or (III) on an absorbent substrate is a synergistic combination.

Test P was a repeat of Test M (Example 7) and produced a result of 1.1 dE_{cmc} units. Test Q was a repeat of Test H (Example 5) and produced a result of 2.5 dE_{cmc} units. The substrate of Test R, without compound (I), produced a much more visible change in the white cloth of 5.9 dE_{cmc} units. These results of Example 8 clearly showed a large, perceptible benefit from using the scavenging substrate of the present invention, compared with using either compound (I) on its own (test Q) or the scavenging substrate without compound (I) (test R).

It is clear from the large difference (5.9 dE_{cmc} units) obtained using the substrate without Compound (I), and the level of improvement found using compound (I) alone (2.5 dE_{cmc} units), that it would not have been expected that combining the substrate of test R and compound (I) would produce such a significant improvement as provided by the combination resulting in the substrate of Example 1 (1.1 dE_{cmc} units). Thus, the combination of the soil scavenging compound (I) and the dye scavenging compound (II) and/or (III) has been shown by these results to have a synergistic effect.

The Examples described herein demonstrate that inclusion of a scavenging substrate of the invention in a washing cycle provides highly effective anti-soil re-deposition in the washing cycle. Repeated experiments confirm that after 10 wash cycles, the whiteness of the original cloth is much better preserved as a result of including the inventive substrate. The original cloth is subjected to a much lesser degree of greying and discolouration in the presence of the inventive substrate. The Examples show that the scavenging substrate of the invention provides improved results using both non-biological and biological washing powders.

The scavenging substrate of the invention is suitable for use in commercial and domestic laundry environments for the purpose of removing undesirable free-flowing dyes from the laundry wash water, and removing soil and dirt from same, thus eliminating undesirable discolouration of some clothes by leached dyes on other clothes, and soil present on other clothes.

1. A scavenging substrate comprising an absorbent substrate bearing a soil scavenging compound having the general formula (I): 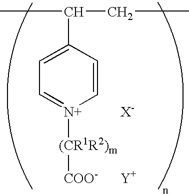
wherein R¹ and R² are each independently hydrogen, C₁₋₅-alkyl or phenyl; X⁻ is an anion, Y⁺ is a cation, m is 1-5 and n is 30-5000.

2. A scavenging substrate as claimed in claim 1, wherein R¹ and R² are each hydrogen, X⁻ is a halide, Y⁺ is an alkali metal cation, m is 1-3 and n is 90-3000.

3. A scavenging substrate as claimed in claim 1, wherein X⁻ is Cl⁻ or Br⁻, Y⁺ is Na⁺ or K⁺, m is 1 and n is 100-1000.

4. A scavenging substrate as claimed in claim 1, wherein the soil scavenging compound (I) is a poly(vinylpyridine betaine) polymer.

5. A scavenging substrate as claimed in claim 4, wherein the soil scavenging compound (I) is poly(4-vinylpyridine) sodium carboxymethyl betaine chloride.

6. A scavenging substrate as claimed in claim 1, wherein the scavenging substrate also bears a dye scavenging compound selected from the following compounds:
(i) N-trisubstituted ammonium-2-hydroxy-3-halopropyl compound having the general formula (II) 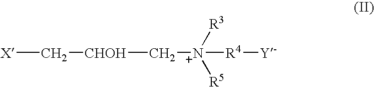
wherein R³, R⁴, R⁵ are each independently methyl, ethyl, butyl or benzyl or an hydroxyl substituted derivative thereof, X′ is a halogen atom, and Y′⁻ is chloride, bromide, sulfate or sulfonate; and
(ii) a salt of epoxy propyl ammonium having the general formula (III), 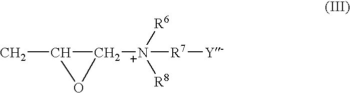
wherein R⁶, R⁷, R⁸ and Y″⁻ have the same meaning as R³, R⁴, R⁵ and Y′⁻ respectively as defined above; or a combination thereof.

7. A scavenging substrate as claimed in claim 6, wherein the dye scavenging compound is a compound of the formula (II) which is 3-chloro-2-hydroxypropyltrimethylammonium chloride.

8. A scavenging substrate as claimed in claim 6, wherein the dye scavenging compound is a compound of the formula (III) which is glycidyltrimethylammonium chloride.

9. A scavenging substrate as claimed in claim 1, wherein the soil scavenging compound (I) is releasably associated with the absorbent substrate.

10. A scavenging substrate as claimed in claim 6, wherein the dye scavenging compound (II) and/or (III) is fixedly associated with the absorbent substrate.

11. A scavenging substrate as claimed in claim 1, wherein the soil scavenging compound (I) is present in an amount of from approximately 2 g to 12 g per square metre of absorbent substrate, preferably from approximately 4 g to 10 g, more preferably from 6.5 g to 7.5 g per square metre of absorbent substrate, especially approximately 6.6 g per square metre of absorbent substrate.

12. A scavenging substrate as claimed in claim 6, wherein the dye scavenging compound (II) and/or (III) is present in an amount of from approximately 10 g to 30 g, preferably from approximately 15 g to 25 g, especially approximately 20 g per square metre of absorbent substrate.

13. A scavenging substrate as claimed in claim 1, wherein the absorbent substrate is formed from a cellulosic material, a textile material, a naturally occurring or synthetic material or a mixture thereof.

14. A scavenging substrate as claimed in claim 13, wherein the absorbent substrate comprises a blend of viscose and cotton.

15. A scavenging substrate as claimed in claim 14, wherein the ratio of viscose to cotton is approximately 90:10 to 10:90, preferably 50:50.

16. A method for the production of a scavenging substrate comprising the steps of:
(a) providing an absorbent substrate; and
(b) applying to the substrate a soil scavenging compound (I) as defined in any of claim 1.

17. A method as claimed in claim 16 further comprising the steps of:
(a)(i) providing an aqueous solution containing a dye scavenging compound of the formula (II) and/or (III), as defined in any of claim 6; and
(a)(ii) at least partially impregnating the absorbent substrate with said aqueous solution;
wherein the steps (a)(i) and (a)(ii) are performed prior to step (b).
